(19) United States
(12) Patent Application Publication
(10) Pub. No.: US 2014/0362156 A1
(43) Pub. Date: Dec. 11, 2014

(54) Thermal Transfer Ribbon Marking

(71) Applicant: Brady Worldwide, Inc., Milwaukee, WI (US)

(72) Inventors: Karl O. Stuen, Fox Point, WI (US); Andrew L. Schmitt, Shorewood, WI (US)

(73) Assignee: Brady Worldwide, Inc., Milwaukee, WI (US)

(21) Appl. No.: 13/911,782

(22) Filed: Jun. 6, 2013

(51) Int. Cl. B41J 2/335

(52) U.S. Cl. CPC B41J 2/335
USPC 347/215

(57) ABSTRACT

Objects of arbitrary shape and size are marked by a method using a thermal transfer ribbon. The method comprises the steps of creating a graphic on a thermal transfer ribbon, joining the graphic-bearing ribbon to a receptor substrate, removing the graphic-bearing ribbon from the receptor substrate, placing the graphic-bearing ribbon on a target object with the graphic in contact with a surface of the target object, applying sufficient heat and pressure to the graphic-bearing ribbon such that the graphic is transferred from the ribbon to the surface of the target object, and removing the ribbon from the surface of the target object.

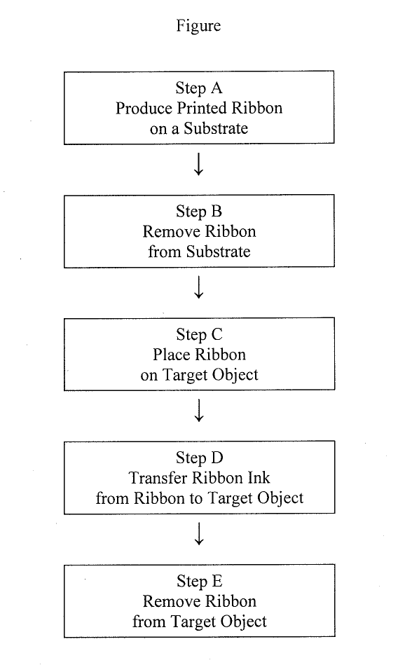

### FIELD OF THE INVENTION

This invention relates to thermal transfer printing. In one aspect the invention relates to marking an object using a thermal transfer printer ribbon while in another aspect, the invention relates to using a transfer receptor with the thermal transfer printer ribbon to mark an object.

### BACKGROUND OF THE INVENTION

Thermal transfer printing creates durable print on labels and signs. Common thermal transfer printers, such as those manufactured by Brady Corporation, use rolls of ribbon and labels that pass under a thermal print head to create images on the labels. This printing technology has been commercially available for many years.

### SUMMARY OF THE INVENTION

In one embodiment the invention is a method of directly marking objects of arbitrary shape and size using a thermal transfer ribbon. The invention specifically allows transferring images to objects such as walls, utility poles, or aircraft. The method comprises the steps of creating a graphic on a thermal transfer ribbon, optionally using a thermal transfer printer, to produce a graphic-bearing ribbon, joining the graphic-bearing ribbon to a receptor substrate, removing the graphic-bearing ribbon from the receptor substrate, placing the graphic-bearing ribbon on a target object with the graphic in contact with a surface of the target object, applying sufficient heat and pressure to the graphic-bearing ribbon such that the graphic is transferred from the ribbon to the surface of the target object, and removing the ribbon from the surface of the target object. The method allows for the direct marking of a surface without the application of a label which may be desirable for technical or aesthetic reasons. For example, in the case of aircraft technical markings, conventional labels are undesirable because they can trap gasses that are released by partially-dried paint coatings. Direct marking of an object with some embodiments of this invention may not trap gasses from partially-dried paint coatings, and may provide improved durability of the mark, such as outdoor weatherability or chemical resistance, compared with labels and other marking methods.

In one embodiment the invention is a method of applying a graphic to a surface of a target object, the method comprising the steps of:
A. Creating a graphic on a thermal transfer ribbon to form a graphic-bearing ribbon, and attaching the graphic-bearing ribbon to a receptor substrate;
B. Removing the graphic-bearing ribbon from the receptor substrate such that the graphic is retained on the ribbon;
C. Applying the graphic-bearing ribbon to a surface of the target object such that the graphic is in contact with the surface of the target object;
D. Applying sufficient heat and pressure to the graphic-bearing ribbon to release the graphic from the ribbon and to attach the graphic to the surface of the target object; and
E. Removing the ribbon from the target object such that the graphic remains on the surface of the target object.

### BRIEF DESCRIPTION OF THE DRAWING

The FIGURE is a schematic rendering of the steps of one embodiment of the invention.

### DETAILED DESCRIPTION OF THE PREFERRED EMBODIMENT

### Definitions

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, temperature, is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the thickness of the transfer ribbon.

“Comprising”, “including”, “having” and like terms mean that the composition, process, etc. is not limited to the components, steps, etc. disclosed, but rather can include other, undisclosed components, steps, etc. In contrast, the term “consisting essentially of” excludes from the scope of any composition, process, etc. any other component, step etc. excepting those that are not essential to the performance, operability or the like of the composition, process, etc. The term “consisting of” excludes from a composition, process, etc., any component, step, etc. not specifically disclosed. The term “or”, unless stated otherwise, refers to the disclosed members individually as well as in any combination.

“Facial surface”, “planar surface”, “top surface”, “bottom surface” and the like are used in distinction to “edge surface”. If rectangular in shape or configuration, a label will comprise two opposing facial surfaces joined by four edge surfaces (two opposing pairs of edge surfaces, each pair intersecting the other pair at right angles). If circular in configuration, then the label will comprise two opposing facial surfaces joined by one continuous edge surface.

“Ink” and like terms mean a coatable or printable formulation that can and usually does contain a dye and/or pigment. “Thermal transfer ink” is an ink carried on a thermal transfer ribbon.

“Dye” and like terms mean a visible light absorbing compound that is present in a molecularly dispersed (dissolved) form.

“Pigment” and like terms mean a visible light absorbing material or compound that is present in a non-molecularly dispersed (particulate) form.

“Graphic”, “graphic image” and like terms mean text or pictorial representations formed of ink or other dye or pigment substances. Graphics include, but are not limited to, words, numbers, bar codes, pictures, designs (geometric or otherwise), and solid colors (typically applied by flood coating).

“Layer” means a single thickness, coating or stratum spread out or covering a surface.

“Multi-layer” means two or more layers with adjacent layers in contact with each other.

“Impermeable” and like terms mean a layer, e.g., a film, coating, etc., that effectively prevents passage of the activating compound from one layer to another layer, or from one layer to an exterior facial surface of an exterior layer of the label.

“Thermal transfer ribbon” means a film with a thermal transfer ink coated on one facial surface.

“Receptor substrate” means a tape or label that accepts thermal transfer ink from the thermal transfer ribbon during the first (image-forming) printing step of the method of the invention. The receptor substrate may consist of a wide range of materials and may consist of a single layer or multiple layers. “Tape” generally refers to pressure-sensitive adhesive tape in roll form that consists of a substrate material with a pressure-sensitive adhesive (PSA) coated on one side. The substrate material is typically between 25 and 75 microns thick. The substrate material in the tape may consist of, but is not limited to polymeric film (polyester, polypropylene, polyethylene, polyimide, polyacrylate, etc.), cloth (woven, non-woven), metal foil, or paper. The substrate material may be coated with a top layer (i.e., topcoat) that imparts thermal transfer ribbon ink receptivity. The top surface may alternatively be print treated to impart thermal transfer ribbon ink receptivity without a top layer of deposited material, such as with a method known as corona treatment, where a corona discharge is placed near the material surface to chemically and physically alter the surface. “Label” is frequently used to denote the same material as “tape” but generally refers to specimens of defined size, whereas “tape” refers to a roll-form continuous material that may be of arbitrary length. To produce a label from a continuous roll of material, the roll may be die-cut in a factory setting (such as with an industrial die-cutting press) or at the point of use in a label printer that includes a cutting unit.

“Target object” means the surface to which the desired marking is applied during the second (image-applying) step of the method of the invention.

“Retransfer sheet” means a tape, label, or other material that accepts a thermal transfer ribbon ink for subsequent application to the surface of a target object. A retransfer sheet is a receptor substrate that allows for the second transfer to a target object. In contrast, some receptor substrates may not be suitable for retransfer.

### Thermal Transfer Ribbon

The thermal transfer ribbon comprises a base substrate, e.g., a plastic film, comprising a coating of ink on one of its facial surfaces. The plastic can be any durable material that will accept, hold and under the influence of heat, release the ink. Typical plastics include but are not limited to polyester, e.g., polyethylene terephthalate (PET), polyimide (PI), polyolefin, e.g., polyethylene, polypropylene, etc., and the like. Typically the thickness of the film for use in thermal transfer printers is from 0.001 millimeters (mm), more typically 0.003 mm and even more typically 0.005 mm, to 0.025 mm, more typically 0.01 mm and even more typically 0.007 mm. Ribbon thicknesses outside of these ranges and associated with typical use may be necessary for robust image transfer using the inventive method.

The ink coating can comprise one or multiple layers, and the thickness of each layer can vary to convenience. Typically the thickness of the ink coating, either as a monolayer or the combined thicknesses of multiple layers, is from 1 micron (μm), more typically 3 μm and even more typically 5 μm, to 15 microns (μm), more typically 10 μm and even more typically 7 μm. In one embodiment the ink coating comprises multiple layers of ink for improved image transfer and image permanence (relative to an ink coating comprising a monolayer). The inks that can be used in the practice of this invention typically comprise a base composition of thermoplastic resin including, but not limited to, polyethylene, polystyrene, polystyrene-polybutadiene copolymer, polyamide, polyester, polyacrylate, polyvinyl chloride, polyvinyl chloride-vinyl acetate copolymer, polyethylene-vinyl acetate copolymer, polyvinyl butyral, polyvinyl alcohol, epoxy, polyurethane, and fluorinated polymers. The ink also typically comprises one or more additives to enhance and/or otherwise optimize its performance characteristics, e.g., weatherability, water and/or chemical resistance, durability, etc. Representative additives include, but are not limited to, pigments, UV absorbers, antioxidants, dispersants, and waxes. Pigments may include organic pigments such as azo pigments, phthalocyanine pigments, quinacridone pigments, isoindolinone pigments, and inorganic pigments such as titanium oxide, zinc oxide, iron oxide, chromium oxide, manganese oxide, bismuth vanadate, and metallic flakes. UV absorbers may include molecules such as 2-hydroxybenzophenones, 2-(2-hydroxyphenyl)-2H-benztriazoles, and 2-(2-hydroxyphenyl)-4,6-phenyl-1,3,5-triazines. Antioxidants include peroxide decomposers (sulfides and phosphites), metal complexing agents and hindered phenols, as well as hindered amine light stabilizers such as derivatives of 2,2,6,6-tetramethylpiperidine. Dispersants include dispersants for water-based coatings such as polymeric anionic surfactants, nonionic surfactants, and potassium tripolyphosphate, and dispersants for solvent-based coatings such as polycaprolactone-polyethylenimine block copolymers, and acrylic based dispersants. Waxes include hydrocarbon waxes (ie polyethylene, polypropylene, paraffin, and carnauba wax), silicone waxes (i.e., polydimethyl siloxane, perfluorononylethyl stearyl dimethicone) or fluorinated waxes (ie polytetrafluoroethylene). These additives are used in known ways and in known amounts.

The ribbon typically also comprises a slip coating on the opposing facial surface to assist the ribbon in moving or sliding over the thermal transfer printer head. Representative slip coatings include, but are not limited to, waxes (e.g., polyethylene wax, polypropylene, paraffin, and carnauba wax), silicone (e.g., polydimethyl siloxane, amino-modified silicone oil) and fluoropolymers (e.g., polytetrafluoroethylene, polyvinylidene fluoride, fluoroethylene-alkyl vinyl ether, fluorinated ethylene propylene). This optional slip coating can, like the ink, comprise either a monolayer or multiple layers. The production of ribbon films with slip coatings is well known and commercial products are commonly available, such as Toray LUMIRROR 531.

In one embodiment the ribbon is attached to a spool prior to placing the ribbon on the target object. In one embodiment the ribbon ink is partially transferred to the target object. In one embodiment the ribbon ink is transferred completely or near completely, e.g., more than 90 percent of the ink on the ribbon, to the target object. In one embodiment a stencil is placed under the ribbon on the target object to create a graphic.

### Thermal Transfer Printer

Thermal transfer printers are well known in the art, and any such printer can be used in the practice of this invention. The purpose of the printer is to transfer the ink on the ribbon to a receptor sheet to form a graphic. The printer converts an electronic, digital graphic into a printed graphic. In terms of functionality, the printer must allow the ribbon to be accessed and removed from the roll upon which it is carried. Exemplary of the thermal transfer printers that can be used in the practice of this invention include the Brady BBP-85, the Brady GLOBALMARK 2, Zebra G-Series GK, and the DURALABEL 9000. Save for the removal of the ribbon, the printers are used in a conventional manner.

The printer may be designed to handle the ribbon in different ways. In one embodiment the ribbon is ejected from the printer with the receptor substrate, in a manner similar in which labels are conventionally printed. In this case the ribbon may be pre-rolled with the substrate into a single roll into the printer, or it may be part of a separate roll that is then laminated with the substrate in the printer. If the ribbon is pre-rolled with the substrate it can also be pre-cut so that cutting the ribbon would not prevent successive print jobs. In another embodiment the ribbon can be kept separate from the receptor sheet and it can be retrieved either through a second ejection path, or by the user removing the ribbon cartridge from the printer and cutting out the desired section of ribbon. The printer could also be designed to handle individual sheets of material, specifically a single receptor sheets each with an overlaid piece of ribbon.

### Receptor Substrate

The receptor substrate, sometimes referred to as a receptor sheet, receives the printed graphic from the thermal transfer ribbon and provides a rigid carrier for the graphic until the graphic is transferred to the target object. In one embodiment the receptor sheet is similar to a label. Alternatively it could be extremely thin, consisting of a material of 1 μm, more preferably 5 μm, and more preferably 10 μm, to 25 μm, more preferably 20 μm, more preferably 15 μm thick, as a means to prevent waste, since the receptor is typically discarded after use. In place of a disposable receptor sheet, use of a drum inside the printer to receive the ink is an option. The collector drum would be expected to have a longer service life than that of the receptor sheet. In one variation of this embodiment, the ink is removed from the drum continuously, such as with a scraper. In another variation of this embodiment, continuous printing on the drum is done without removing the ink.

In one embodiment the receptor substrate is patterned with an adhesive to help the ribbon remain attached to it during and after printing. For example, thin strips of adhesive on either edge of the facial surface of the receptor to which the ribbon is attached can hold the ribbon in place without affecting the printing process or the print quality. A removable pressure sensitive adhesive (PSA) can be used to allow the ribbon to be peeled off of the receptor when desired.

### Final Transfer Device

This device applies heat and pressure to the printed ribbon on the receptor sheet to transfer the printed graphic from the receptor sheet to the target object. The device can vary in shape, size and design, and includes such diverse instruments as a heated roller (e.g., a handheld roller with a silicone surface and a heating element within the roller), a heated iron with a metal or elastomeric ironing surface), and a heated air bladder (useful for applying heat and pressure uniformly across the surface of the printed ribbon.) In one embodiment the device is heated, pressurized air, e.g., air from a heat gun with a nozzle. In another embodiment the device is a heated roller with the printed ribbon wrapped around it. Important to the operation of the final transfer device is its ability to impart sufficient heat and pressure to the printed receptor sheet that the printed graphic effectively transfers to the target object. Typical operating temperatures for the device are temperatures from 50° C., preferably from 150° C. and more preferably from 160° C. to 200° C., preferably to 180° C. and more preferably to 170° C. Typical operating pressures for the device are pressures from 1 kPa, preferably from 10 kPa and more preferably from 100 kPa to 10 MPa, preferably to 1 MPa and more preferably to 200 kPa. For a roller device that applies pressure along a linear roller nip, typical operating pressures are from 100 g/cm, preferably from 500 g/cm and more preferably 800 g/cm to 10 kg/cm preferably 5 kg/cm and more preferably 2 kg/cm.

### Target Object

The target objects can vary widely in size, shape and composition, and include such diverse materials as metal, plaster, wood, ceramic, cement, plastic and stone. The surface of the target object can be coated or uncoated, and preferably is clean, dry and smooth. The method of this invention is particularly well suited for marking large, coated metals such as those used in the aircraft industry.

### Method of the Invention

The Figure is a schematic description of the steps of this invention. Step A comprises printing a graphic from a thermal transfer ribbon. Compared with conventional thermal transfer printing, the graphic is printed in reverse tone so that the ink remaining on the ribbon will form the graphic in step D. The graphic is printed from the ribbon using a thermal transfer printer and after the ribbon is printed with the graphic, it is removed from the printer either attached to a receptor substrate, or separately, and may then be subsequently attached to the receptor substrate. The graphic-bearing ribbon is attached to the receptor substrate in a releasable manner, i.e., in a manner that allows for the easy removal of the ribbon from the substrate, e.g., peeling the ribbon from the substrate, at the time the graphic is ready for transfer from the ribbon to the target object. In one embodiment the ribbon is attached to a receptor substrate prior to the time of printing the graphic to the ribbon. In one embodiment the ribbon is attached to the receptor substrate at the same time the graphic is printed to the ribbon. In one embodiment the ribbon is attached to the receptor after the graphic is printed to the ribbon. In one embodiment, the ribbon is not attached to the receptor after printing. In one embodiment, the ribbon is attached to a spool after printing, either automatically inside the printer, or manually outside the printer, for ease of transporting and for lying onto the target object.

Step B comprises removing the ribbon from the receptor sheet (if it is attached). The graphic to be transferred to the target object is retained on the ribbon.

Step C comprises applying the graphic-bearing ribbon to the target object such that the graphic is in contact with the target object.

Step D comprises applying sufficient heat and pressure to the graphic-bearing ribbon to release the graphic from the ribbon and join it to the target object. The amount of heat and pressure necessary to transfer the graphic from the ribbon to a surface of the target object and to durably adhere the graphic to the surface of the target object will vary with the nature of the ribbon, graphic ink and target object surface, but typically the temperature of the means by which the transfer is accomplished is from 50° C., preferably from 150° C. and more preferably from 160° C. to 200° C., preferably to 180° C. and more preferably to 170° C., and typically the pressure at which the means contacts the ribbon is from 1 kPa, preferably from 10 kPa and more preferably from 100 kPa to 10 MPa, preferably to 1 MPa and more preferably to 200 kPa. As noted above, the means of applying the transfer temperature and pressure to the ribbon can vary widely and include such means as a heated roller, a heated iron, a heated air bladder, and simply heated and pressurized air applied from nozzle.

In final Step E the ribbon is removed, e.g., peeled, from the target object such that the graphic remains on, e.g., is fused with, the surface of the target object.

The method of this invention is characterized by one or more, typically more, desirable features not necessarily provided by alternative methods of marking objects of arbitrary shape and size. These features include:
A. Allowing the ribbon to fuse to the receptor substrate as opposed to being taken up onto a rewind spool;
B. Removing the printed ribbon from the printer;
C. Storing the printed ribbon (if necessary or desirable) prior to final transfer of the graphic from the ribbon to the surface of the target object;
D. Placing the ribbon directly onto a surface of a target object and
E. Transferring ribbon ink to a target object with a thermal transfer device.

Other desirable features of the invention include that the ribbon can be printed on demand and then stored for use at a later date, the ribbon can be aligned on a surface of a target object prior to printing, and the graphic can be readily applied to a curved surface.

The method of this invention provides several advantages over known alternative methods of marking objects of arbitrary size and shape. For example, a method that uses a retransfer sheet as an intermediate ink receptor to transfer a graphic to the surface of a target object transfers the ink twice, once from the ribbon to the retransfer sheet and once from the retransfer sheet to the object. With the present invention, each ink pixel is transferred once. In the retransfer method the initial transfer may affect the polymer binder morphology or layer integrity and may thermally degrade the ink. As such, some ink may transfer poorly affecting print quality and the durability of the final marking. Also, in the retransfer method the ink reverses the side that touches the target object. For a multilayered ink, this can affect performance.

Another desirable feature of the inventive method is that the ribbon, which is typically optimized for releasing the ink, is used to create the final image. With a process that uses a retransfer sheet, for example, considerations such as the thickness and rigidity of the material can become an issue. For example, it may be beneficial to have a thick receptor substrate for the purpose of durability and handling, but better to have a thin sheet for final transfer to the target object. The current invention overcomes this problem by allowing the ribbon to function only as an ink donor during both transfers. A thin ribbon, for example, can work well for both the initial and final transfers and rely on the receptor sheet for handling durability.

In one embodiment the thermal transfer ribbon is printed through the use of a thermal transfer printer.

In one embodiment the thermal transfer ribbon is printed without the use of a thermal transfer printer. In this alternative embodiment blocks of ink are transferred to the ribbon without a printer. For example the ribbon can be pre-printed at a factory. Alternatively, a physical stencil can be used with the ribbon to create the graphic.

What is claimed is:

1. A method of applying a graphic to a surface of a target object, the method comprising the steps of:
A. Creating a graphic on a thermal transfer ribbon to form a graphic-bearing ribbon, and attaching the graphic-bearing ribbon to a receptor substrate;
B. Removing the graphic-bearing ribbon from the receptor substrate such that the graphic is retained on the ribbon;
C. Applying the graphic-bearing ribbon to a surface of the target object such that the graphic is in contact with the surface of the target object;
D. Applying sufficient heat and pressure to the graphic-bearing ribbon to release the graphic from the ribbon and to attach the graphic to the surface of the target object; and
E. Removing the ribbon from the target object such that the graphic remains on the surface of the target object.

2. The method of claim 1 in which the graphic is printed from the ribbon using a thermal transfer printer.

3. The method of claim 1 in which the receptor substrate is a drum.

4. The method of claim 2 in which the graphic is printed from the ribbon at the same time that the ribbon is attached to the receptor substrate.

5. The method of claim 2 in which the graphic is printed from the ribbon prior to the attachment of the ribbon to the receptor substrate.

6. The method of claim 2 in which the graphic is printed from the ribbon and is not attached to the receptor substrate.

7. The method of claim 1 in which the ribbon is attached to a spool prior to placing the ribbon on the target object.

8. The method of claim 1 in which the ribbon ink is transferred completely or near completely to the target object.

9. The method of claim 1 in which a stencil is placed under the ribbon on the target object to create a graphic.

10. The method of claim 1 in which the graphic of the graphic-bearing ribbon is transferred to the surface of the target object at a temperature of 50° C. to 200° C. and at a pressure of 1 kPa to 10 MPa.
